(19) United States
(12) Patent Application Publication
(10) Pub. No.: US 2012/0262542 A1
(43) Pub. Date: Oct. 18, 2012

(54) DEVICES AND METHODS FOR WARPING AND HOLE FILLING DURING VIEW SYNTHESIS

(75) Inventors: Karthic Veera, SAN DIEGO, CA (US); Ying Chen, SAN DIEGO, CA (US); Junchen Du, SAN DIEGO, CA (US); Marta Karczewicz, SAN DIEGO, CA (US)

(73) Assignee: QUALCOMM INCORPORATED, San Diego, CA (US)

(21) Appl. No.: 13/301,319

(22) Filed: Nov. 21, 2011

Related U.S. Application Data
(60) Provisional application No. 61/476,199, filed on Apr. 15, 2011.

(51) Int. Cl. H04N 9/74; H04N 13/00; H04N 5/14

(52) U.S. Cl. 348/42; 348/571; 348/578; 348/E05.062; 348/E09.054; 348/E13.001

(57) ABSTRACT

Implementations include methods and systems for a converting reference images or video to 3D images or video. A two-step conversion is described which accomplishes warping and hole filling on a pixel-by-pixel basis. In one implementation, of a plurality of pixel values of a reference image at a plurality of first collinear pixels locations are successively mapped to a respective plurality of second pixel locations of a destination image. Between two of the mappings, a location of a hole between two of the second pixel locations may be identified and filled.

### CROSS-REFERENCE TO RELATED APPLICATIONS

This application claims priority from U.S. Provisional Patent Application No. 61/476,199, entitled “Combination of 3D Warping and Hole Filling in View Synthesis,” filed Apr. 15, 2011, which is incorporated by reference in its entirety.

### BACKGROUND

1. Field

The present implementations relate to image conversion, and in particular, to video image conversion systems, method and apparatus for warping and hole filling during view synthesis.

2. Background

A wide range of electronic devices, including mobile wireless communication devices, personal digital assistants (PDAs), laptop computers, desktop computers, digital cameras, digital recording devices, and the like, have an assortment of image and video display capabilities. Some devices are capable of displaying two-dimensional (2D) images and video, three-dimensional (3D) images and video, or both.

In some instances, images or video may be transmitted to a device that has certain 3D capabilities. In this instance, it may be desirable to convert the images or video to a 3D image or video. The conversion to 3D may be computationally intensive and may introduce visual artifacts that reduce the aesthetic appeal of the converted 3D image or video as compared with the original images or video. Accordingly, improved methods and apparatus for converting images or video to a 3D image or video are needed.

### SUMMARY

Various embodiments of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various implementations are used to provide conversion of images, performed on at least one computer processor.

In one aspect of the disclosure, a method of video image processing is provided. The method includes selecting a mapping direction to process a plurality of pixel values of a reference image at a plurality of first collinear pixel locations. The method includes successively mapping each of the plurality of pixel values to a respective plurality of second pixel locations of a destination image. Between two consecutive mappings, the method includes determining a location of a hole between two of the second pixel locations.

The method may include determining the location of a hole comprises identifying a pixel location between a first mapped-to location in the destination image and a second mapped-to location in the destination image, the second mapped-to location being a location in a same direction as the mapping direction. In some implementations, the method includes between a first mapped-to location in the destination image and a second mapped-to location in the destination image, the first mapped-to location and the second mapped-to location being consecutive mappings, determining a pixel value for the second mapped-to location, if the mapped-to pixel locations are the same or have an opposite direction in the destination image as the mapping direction. In some implementations, the method includes determining a pixel value for a location determined to be a hole based on a comparison of depth values from the reference image for a pixel at the first mapped-to location and a pixel at the second mapped-to location. The pixel value for the second mapped-to location may be based on a comparison of depth values from the reference image for a pixel at the first mapped-to location and a pixel at the second mapped-to location. The pixel value may include a color component and an intensity value associated with the color component. In some implementations, the mapping includes mapping from a 2D reference image to a 3D destination image. In some implementations, the 3D destination image comprises a 3D stereo image pair including the 2D reference image. In an aspect, the method includes setting a depth value for a location in the destination image upon mapping a pixel value to the location, wherein the location is a non-hole. In an aspect, when the location is a hole, the method may include identifying the location as unmapped until the location is subsequently mapped-to. If the pixel value of the second mapped-to location is used as the pixel value of the determined location, the method may include detecting in an opposite direction of the mapping direction, pixel locations which are marked as unmapped and are adjoining to the second mapped-to location in the destination image. In some implementations, these locations may be identified as a continuous hole.

An additional innovative facet of the disclosure provides a video conversion device. The device includes means for selecting a mapping direction to process a plurality of pixel values of a reference image at a plurality of first collinear pixel locations. The device also includes means for successively mapping, along the mapping direction, each of a the plurality of image pixel values of a reference image at a plurality of first collinear pixels locations to a respective plurality of second pixel locations of a destination image. The device further includes means for, between two of the consecutive mappings, determining a location of a hole between two of the second pixel locations.

In yet another innovative aspect, another video conversion device is provided. The device includes a processor. The device includes a pixel extracting circuit coupled with the processor and configured to consecutively extract pixels from a reference image in a specified mapping direction. The device includes a pixel warping circuit coupled with the processor and configured to determine a location for an extracted pixel in a destination image. The device includes a hole detecting circuit coupled with the processor and configured to identify an empty pixel location in the destination image between the location for the extracted pixel and a previously determined location for a previously extracted pixel. The device also includes a hole filling circuit coupled with the processor and configured to generate a pixel value for the empty pixel location in the destination image.

In some implementations, the pixel extracting circuit is configured to extract a second pixel after the hole detecting circuit and hole filling circuit finish operation on a first pixel. The reference image may be a 2D image. The destination image may be a 3D destination image. The 3D destination image comprises a 3D stereo image pair including the 2D reference image. The pixel warping circuit may be configured to determine a location for the extracted pixel in the destination image based on an offset from the pixel location in the reference image. In some implementations, the hole detecting circuit is configured to identify between a first mapped-to location in the destination image and a second mapped-to location in the destination image, the first mapped-to location and the second mapped-to location being consecutive mappings, determining a pixel value for the second mapped-to location, if the mapped-to pixel locations are the same or have an opposite direction in the destination image as the mapping direction. The hole filling circuit may be configured to generate the pixel value for the second mapped-to location is based on a comparison of depth values from the reference image for a pixel at the first mapped-to location and a pixel at the second mapped-to location. In some implementations, the hole filling circuit is configured to identify an empty pixel location between a first mapped-to location in the destination image and a second mapped-to location in the destination image, the second mapped-to location having a same direction as the mapping direction. In some implementations, the hole filling circuit is configured to generate a pixel value for the identified empty pixel location based on a comparison of depth values from the reference image for a pixel at the first mapped-to location and a pixel at the second mapped-to location. The pixel value may include a color component and an intensity value associated with the color component. The hole filling circuit may be further configured to set a depth value for a location in the destination image upon mapping a pixel value to the location, wherein the location is a non-hole and, when the location is a hole, identify the location as unmapped until the location is subsequently mapped-to.

Another innovative aspect of the disclosure provides a video image processing computer program product comprising a computer-readable medium having stored thereon instructions. The instructions are executable by a processor of an apparatus to cause the apparatus to select a mapping direction to process a plurality of pixel values of a reference image at a plurality of first collinear pixel locations. The instructions further cause the apparatus to successively map along the mapping direction each of the plurality of pixel values to a respective plurality of second pixel locations of a destination image. The instructions further cause the apparatus to, between two consecutive mappings, determine a location of a hole between two of the second pixel locations.

In some implementations, determining the location of a hole comprises identifying a pixel location between a first mapped-to location in the destination image and a second mapped-to location in the destination image, the second mapped-to location being a location in a same direction as the mapping direction. In some implementations, instructions causing the apparatus to, between a first mapped-to location in the destination image and a second mapped-to location in the destination image, the first mapped-to location and the second mapped-to location being consecutive mappings, determine a pixel value for the second mapped-to location, if the mapped-to pixel locations are the same or have an opposite direction in the destination image as the mapping direction. Instructions may also be provided to cause the apparatus to determine a pixel value for the determined location based on a comparison of depth values from the reference image for a pixel at the first mapped-to location and a pixel at the second mapped-to location. Instructions causing the apparatus to determine a pixel value for the determined location based on a comparison of depth values from the reference image for a pixel at the first mapped-to location and a pixel at the second mapped-to location may also be included. The pixel value may include a color component and an intensity value associated with the color component. In some implementations, mapping each of a plurality of pixel values comprises mapping from a 2D reference image to a 3D destination image. In some implementations, the 3D destination image comprises a 3D stereo image pair including the 2D reference image.

### BRIEF DESCRIPTION OF THE DRAWINGS

So that the manner in which features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 shows a functional block diagram of an exemplary video encoding and decoding system.

FIG. 2 shows a functional block diagram of an exemplary video encoder.

FIG. 3 shows a functional block diagram of an exemplary video decoder.

FIG. 4 shows a functional block diagram of an exemplary 3D conversion processor.

FIG. 5 shows an exemplary process flow diagram for 3D pixel warping and hole detection.

FIG. 6 shows an exemplary process flow diagram for updating hole filling.

FIG. 7A shows exemplary pixel mappings from a reference view to a destination view.

FIG. 7B shows other exemplary pixel mappings from a reference view to a destination view.

FIG. 7C shows other exemplary pixel mappings from a reference view to a destination view.

FIG. 7D shows other exemplary pixel mappings from a reference view to a destination view.

FIG. 7E shows another exemplary pixel mapping from a reference view to a destination view.

FIG. 8 shows a flowchart for an exemplary method of generating an image.

FIG. 9 shows a functional block diagram of an exemplary video conversion device.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Various methods exist for generating realistic 3D images from reference images. One method is depth image based rendering (DIBR). Depth image based rendering synthesizes a virtual view from a given input view and its associated depth maps. A depth map generally refers to an identification of a relative or absolute distance a particular pixel is from the camera. In DIBR, two steps may be performed to generate the 3D image: (1) 3D warping, which warps texture of the input view to the virtual destination image based on depth maps; and (2) hole filling, which fills the pixel locations in the virtual view wherein no pixel is mapped.

In 3D warping, given the depth and the camera model, a pixel of a reference view is first projected from the reference image camera coordinate to a point in a world-space coordinate. A camera model generally refers to a computational scheme representing the relationships between a 3D point and its projection onto an image plane. This point is then projected to a pixel in a destination image (the virtual view to be generated) along the direction of a view angle of the destination image (e.g., the point of observation of a viewer). Warping may be used to convert a 2D reference image to a 3D destination image. Warping may be used to convert a 3D reference image to a different 3D destination image.

Sometimes, more than one view can be considered as reference views. The above mentioned projection may not be a one-to-one projection. When more than one pixel is projected to a pixel in the destination image, a visibility problem occurs, namely determining which pixel of the multiple projected pixels should be visible in the destination image. Conversely, when no pixel is projected to a pixel in the destination image, a hole may exist in the picture of the virtual view. If the holes exist in a destination image for a continuous area, the phenomena may be referred to as occlusion. If the holes distributed sparsely in a picture, they may be referred to as pinholes. Occlusion can be solved by introducing one reference view in a different direction. To fill pinholes by hole filling, neighboring pixels can be taken as candidate pixel values for filling the hole. The methods for pinhole filling can also be used to solve the occlusion problem. For example, when more than one pixel is considered for the pixel values of a pixel in the destination image, certain weighted average methods can be employed. This process may be referred to as reconstruction in view synthesis.

One method of warping is based on a disparity value. When the parameters for the reference view image are fixed, for each pixel with a given depth value in the input view, a disparity value can be calculated. Disparity generally refers to an offset number of pixels a given pixel in a reference view image will be shifted to produce a realistic 3D destination image. The disparity value may contain only a displacement in the horizontal direction. However, in some implementations, disparity value may contain a displacement in the vertical direction. Based on the calculated disparity value, the pixel will be warped to the destination image. When multiple pixels are mapped to the same location, one way to solve the problem is to select the pixel that is closest to the camera.

The following describes methods and systems to provide efficient conversion of images or video to 3D images or video that addresses the above mentioned aspects of 3D warping based view synthesis, namely: visibility, occlusion, hole filling, and reconstruction. 3D warping and hole filling may be handled as two separate processes. A first 3D warping process maps all the pixels in the reference image. Then, a hole-filling process checks all pixels in the destination image and fills any holes that may be identified. According to this two-step process, the memory region may be traversed twice, once for 3D warping and again to identify the holes. This method can increase the instructions needed for the conversion algorithm and also could potentially increase cache miss rate. This method may further require more bus traffic thereby increasing power consumption. Accordingly, a more efficient method of 3D warping with hole filling is desirable.

A method is described below that handles the 3D warping and hole-filling in one process. More specifically, only one loop is required to check each of the pixels in the input reference image to finish the view synthesis of the whole image. For example, one loop may be utilized to traverse each pixel of each row when generating from an original image to a destination image. During each iteration of this loop, both image projection (calculating the destination location of a pixel in the original image), such as warping, and hole filling are processed for one or more pixels. In some implementations, when warping one pixel to a specific location of the destination image, not only the pixel in the specific location but also the nearby pixels may be updated with new depth value and color values. A pixel may be temporally detected as a hole, when it is between two mapped-to pixels in two consecutive iterations belonging to the same horizontal line. When a hole is temporally detected, the hole may be immediately filled, at least temporarily, by one of the two mapped-to pixels in these two iterations, based on whose depth value corresponds to z-value (e.g., depth value) corresponding to being closer to the camera.

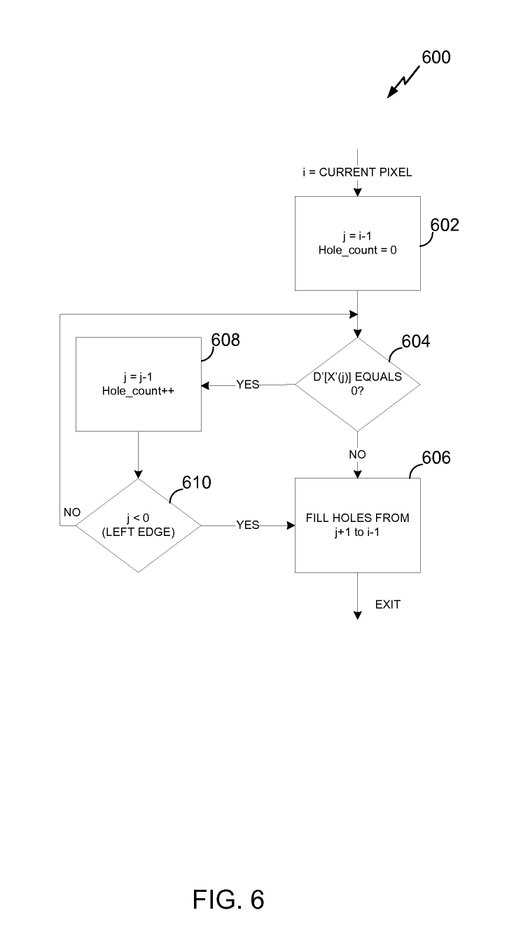

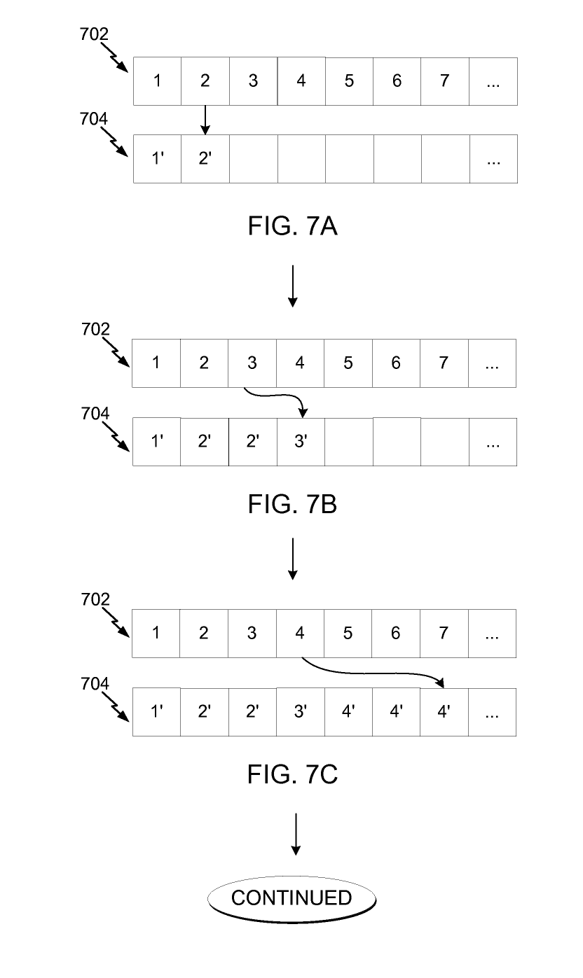

In some cases, a pixel may be mapped to a position which is already mapped. The z-buffering may decide to replace the position with the value(s) of the new pixel (e.g., depth of the pixel greater than the pixel mapped at the position). Since value(s) of the pixel being replaced may have been previously used to fill a hole adjacent to the mapped-to location, it may be desirable to re-fill the hole in consideration of the newly mapped pixel. Accordingly, in an implementation where pixels are processed left to right, consecutive holes adjacent to the mapped-to location on the left of a horizontal line may be re-filled based on the new value(s) of the mapped to pixel and the first non-hole pixel on the left of the holes. For example, as a result of a mapping, a hole may exist between pixel locations A and Z. This hole may be filled considering the pixel values mapped at location A and location Z. Subsequently, location N may be mapped with a different pixel value. In this case, the hole between locations A and N must be re-evaluated considering the pixel values mapped at location A and location N. This process is described in further detail below in reference to FIGS. 6 and 7.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various aspects of embodiments within the scope of the appended claims are described below. It should be apparent that the aspects described herein may be embodied in a wide variety of forms and that any specific structure and/or function described herein is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

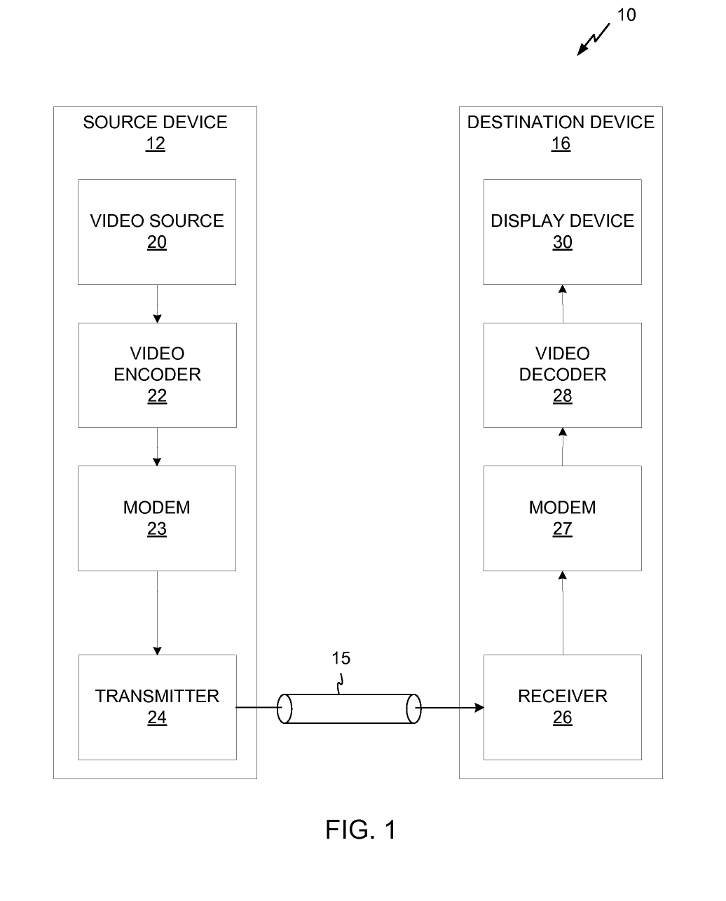

FIG. 1 shows a functional block diagram of an exemplary video encoding and decoding system. As shown in FIG. 1, system 10 includes a source device 12 that transmits encoded video to a destination device 16 via a communication channel 15. Source device 12 and destination device 16 may comprise any of a wide range of devices, including mobile devices or generally fixed devices. In some cases, source device 12 and destination device 16 comprise wireless communication devices, such as wireless handsets, so-called cellular or satellite radiotelephones, personal digital assistants (PDAs), mobile media players, or any devices that can communicate video information over a communication channel 15, which may or may not be wireless. However, the techniques of this disclosure, which concern the generation of 3D images or video from reference images or video, may be used in many different systems and settings. FIG. 1 is merely one example of such a system.

In the example of FIG. 1, source device 12 may include a video source 20, video encoder 22, a modulator/demodulator (modem) 23 and a transmitter 24. Destination device 16 may include a receiver 26, a modem 27, a video decoder 28, and a display device 30. In accordance with this disclosure, video encoder 22 of source device 12 may be configured to encode a sequence of frames of a reference image. The video encoder 22 may be configured to encode 3D conversion information, wherein the 3D conversion information comprises a set of parameters that can be applied to each of the video frames of the reference sequence to generate 3D video data. Modem 23 and transmitter 24 may modulate and transmit wireless signals to destination device 16. In this way, source device 12 communicates the encoded reference sequence along with the 3D conversion information to destination device 16.

Receiver 26 and modem 27 receive and demodulate wireless signals received from source device 12. Accordingly, video decoder 28 may receive the sequence of frames of the reference image. The video decoder 28 may receive the 3D conversion information decoding the reference sequence. According to this disclosure, video decoder 28 may generate the 3D video data based on the sequence of frames of the reference image. The video decoder 28 may generate the 3D video data based on the 3D conversion information. Again, the 3D conversion information may comprise a set of parameters that can be applied to each of the video frames of the reference sequence to generate 3D video data, which may comprise significantly less data than would otherwise be needed to communicate a 3D sequence.

As mentioned, the illustrated system 10 of FIG. 1 is merely exemplary. The techniques of this disclosure may be extended to any coding device or technique that supports first order block-based video coding.

Source device 12 and destination device 16 are merely examples of such coding devices in which source device 12 generates coded video data for transmission to destination device 16. In some cases, devices 12, 16 may operate in a substantially symmetrical manner such that, each of devices 12, 16 includes video encoding and decoding components. Hence, system 10 may support one-way or two-way video transmission between video devices 12, 16, e.g., for video streaming, video playback, video broadcasting, or video telephony.

Video source 20 of source device 12 may include a video capture device, such as a video camera, a video archive containing previously captured video, or a video feed from a video content provider. As a further alternative, video source 20 may generate computer graphics-based data as the source video, or a combination of live video, archived video, and computer-generated video. In some cases, if video source 20 is a video camera, source device 12 and destination device 16 may form so-called camera phones or video phones. In each case, the captured, pre-captured or computer-generated video may be encoded by video encoder 22. The encoded video information may then be modulated by modem 23 according to a communication standard, e.g., such as code division multiple access (CDMA) or another communication standard, and transmitted to destination device 16 via transmitter 24. Modem 23 may include various mixers, filters, amplifiers or other components designed for signal modulation. Transmitter 24 may include circuits designed for transmitting data, including amplifiers, filters, and one or more antennas.

Receiver 26 of destination device 16 receives information over channel 15, and modem 27 demodulates the information. Again, the video encoding process may implement one or more of the techniques described herein to determine a set of parameters that can be applied to each of the video frames of the reference sequence to generate 3D video data. The information communicated over channel 15 may include information defined by video encoder 22, which may be used by video decoder 28 consistent with this disclosure. Display device 30 displays the decoded video data to a user, and may comprise any of a variety of display devices such as a cathode ray tube, a liquid crystal display (LCD), a plasma display, an organic light emitting diode (OLED) display, or another type of display device.

In the example of FIG. 1, communication channel 15 may comprise any wireless or wired communication medium, such as a radio frequency (RF) spectrum or one or more physical transmission lines, or any combination of wireless and wired media. Accordingly, modem 23 and transmitter 24 may support many possible wireless protocols, wired protocols or wired and wireless protocols. Communication channel 15 may form part of a packet-based network, such as a local area network (LAN), a wide-area network (WAN), or a global network, such as the Internet, comprising an interconnection of one or more networks. Communication channel 15 generally represents any suitable communication medium, or collection of different communication media, for transmitting video data from source device 12 to destination device 16. Communication channel 15 may include routers, switches, base stations, or any other equipment that may be useful to facilitate communication from source device 12 to destination device 16. The techniques of this disclosure do not necessarily require communication of encoded data from one device to another, and may apply to encoding scenarios without the reciprocal decoding. Also, aspects of this disclosure may apply to decoding scenarios without the reciprocal encoding.

Video encoder 22 and video decoder 28 may operate consistent with a video compression standard, such as the ITU-T H.264 standard, alternatively described as MPEG-4, Part 10, and Advanced Video Coding (AVC). The techniques of this disclosure, however, are not limited to any particular coding standard or extensions thereof. Although not shown in FIG. 1, in some aspects, video encoder 22 and video decoder 28 may each be integrated with an audio encoder and decoder, and may include appropriate MUX-DEMUX units, or other hardware and software, to handle encoding of both audio and video in a common data stream or separate data streams. If applicable, MUX-DEMUX units may conform to a multiplexer protocol (e.g., ITU H.223) or other protocols such as the user datagram protocol (UDP).

Video encoder 22 and video decoder 28 each may be implemented as one or more microprocessors, digital signal processors (DSPs), application specific integrated circuits (ASICs), field programmable gate arrays (FPGAs), discrete logic circuitry, software executing on a microprocessor or other platform, hardware, firmware or any combinations thereof. Each of video encoder 22 and video decoder 28 may be included in one or more encoders or decoders, either of which may be integrated as part of a combined encoder/decoder (CODEC) in a respective mobile device, subscriber device, broadcast device, server, or the like.

A video sequence typically includes a series of video frames. Video encoder 22 and video decoder 28 may operate on video blocks within individual video frames in order to encode and decode the video data. The video blocks may have fixed or varying sizes, and may differ in size according to a specified coding standard. Each video frame may include a series of slices or other independently decodable units. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform or a conceptually similar transformation process.

Macroblocks or other video blocks may be grouped into decodable units such as slices, frames or other independent units. Each slice may be an independently decodable unit of a video frame. Alternatively, frames themselves may be decodable units, or other portions of a frame may be defined as decodable units. In this disclosure, the term “coded unit” refers to any independently decodable unit of a video frame such as an entire frame, a slice of a frame, a group of pictures (GOPs), or another independently decodable unit defined according to the coding techniques used.

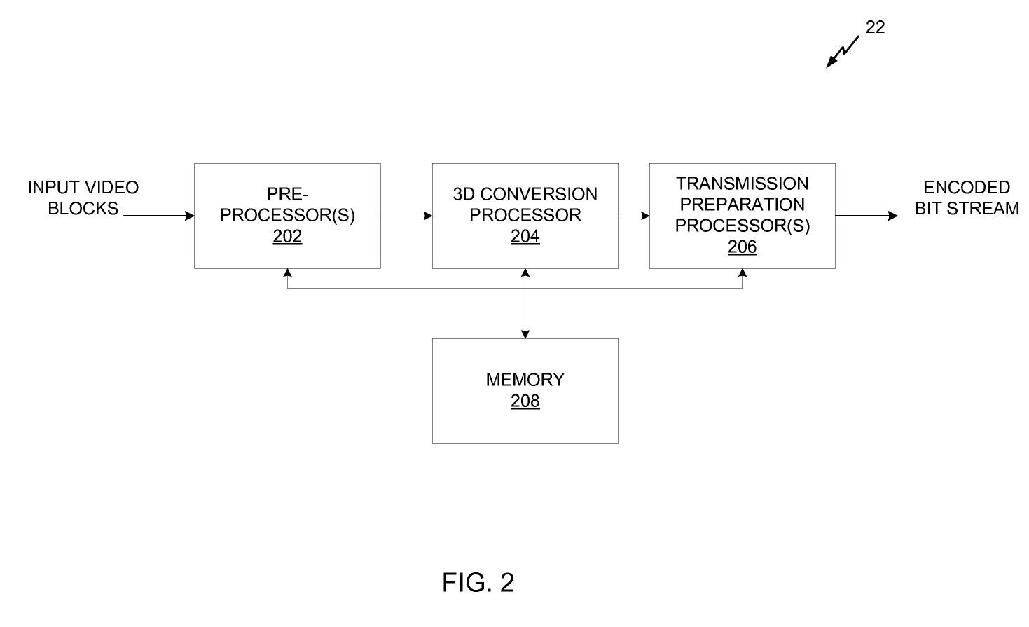

FIG. 2 shows a functional block diagram of an exemplary video encoder. In some implementations, it may be desirable to convert the reference images or video to 3D images or video prior to encoding. For example, if the target display device is 3D capable, the encoder may perform the conversion and deliver a 3D encoded video stream to the target display device. The video encoder 22 may include one or more pre-processor(s) 202. The pre-processor(s) 202 may include various modules configured to process the input video blocks. Pre-processing modules such as quantization units, entropy coding units, encryption units, scrambling units, descrambling units and the like may be included. In some applications, where no pre-processing of the input video blocks is needed, no pre-processor(s) 202 is included in the video encoder 22. In some implementations, the pre-processor may be configured to adjust a pixel value for each pixel such as adjusting a depth value for each pixel to be greater than zero.

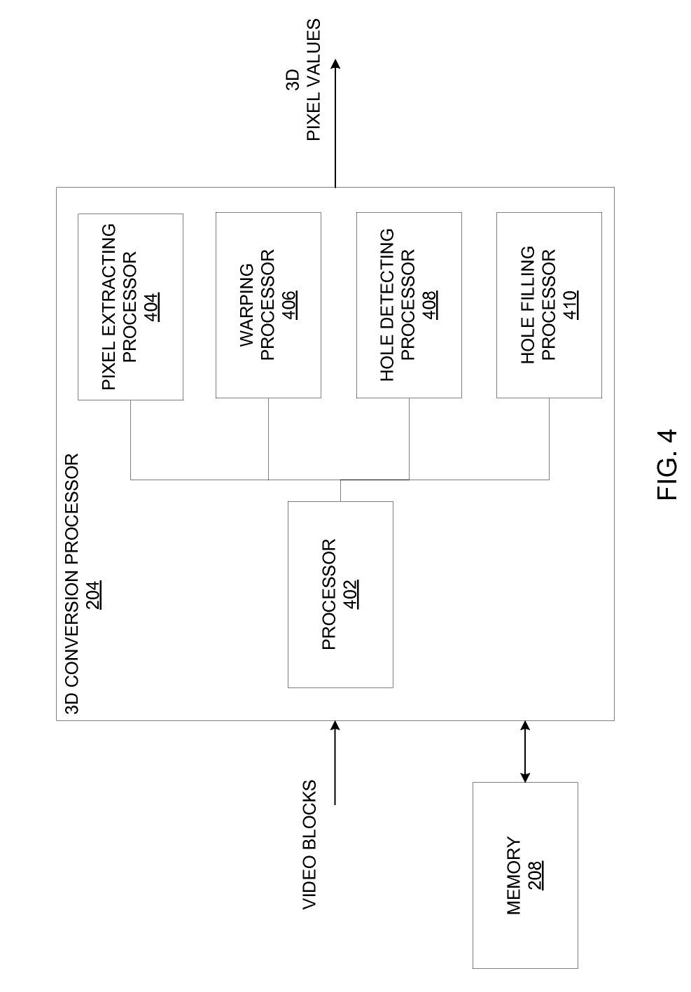

The pre-processor(s) 202 is coupled with a 3D conversion processor 204 which will be described further below in reference to FIG. 4. In some implementations, where 3D conversion is not required, the 3D conversion processor 204 may be bypassed or omitted from the video encoder 22. The 3D conversion processor 204 may be coupled with one or more transmission preparation processor(s) 206. The transmission preparation processors(s) 206 may include encoding processors, buffering processors, prediction processors, and other components used to prepare the converted input video blocks into an encoded bit stream for transmission.

Each of the pre-processor(s) 202, 3D conversion processor 204, and the transmission preparation processor(s) 206 are coupled with a memory 208. The memory may be used to store the input video blocks at various stages within the video encoder. In some implementations, the processors directly transmit the input video blocks to each other. In some implementations, the processors provide one or more input video blocks to a subsequent processor by storing the input video blocks in the memory 208. Each processor may also use the memory 208 during processing. For example, the transmission preparation processor(s) 206 may use the memory 208 as an intermediate storage location for encoded bits of input video blocks.

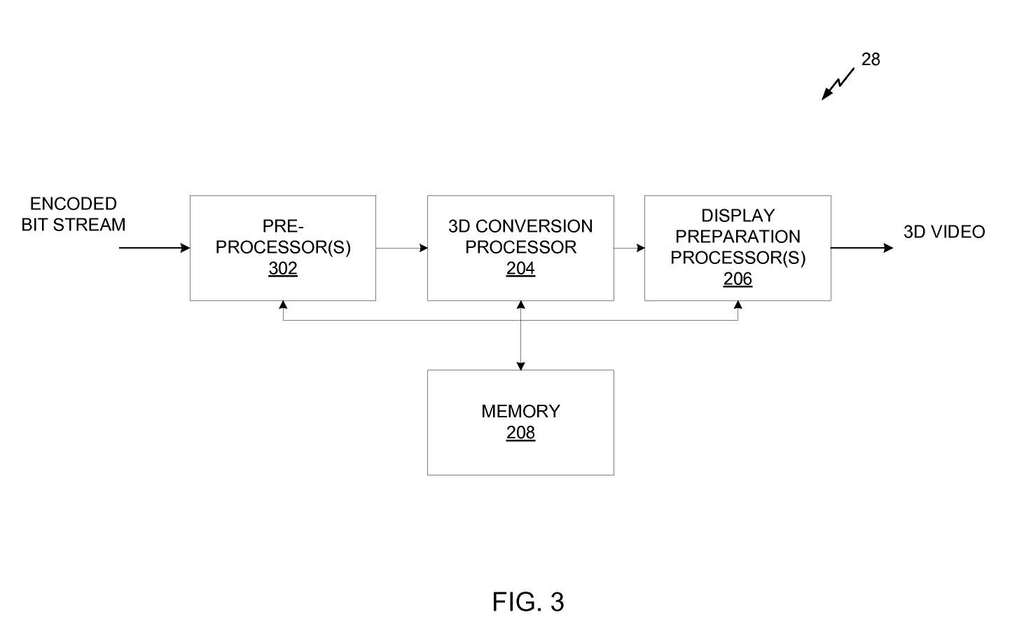

FIG. 3 shows a functional block diagram of an exemplary video decoder. In some implementations, it may be desirable to convert the 2D video to 3D video after decoding the bit stream. For example, if the target display device is capable to convert encoded 2D bit streams to 3D video, the decoder may perform the conversion on a 2D encoded video stream. The video decoder 28 may include one or more pre-processor(s) 302. The video decoder 28 may include a 3D conversion processor 204 which will be described in further detail below in reference to FIG. 4. The video decoder 28 may include a display preparation processor(s) 206. The video decoder 28 may include a memory 208.

FIG. 4 shows a functional block diagram of an exemplary 3D conversion processor. The 3D conversion processor 204 includes a processor 402. The processor 402 may be configured to control the operation of the 3D conversion processor 204. The processor 402 may include multiple processing units. One or more of the processor units 204 of the processor 402 may be collectively referred to as a central processing unit (CPU).

The processor 402 may be coupled with a pixel extracting processor 404. The pixel extracting processor 404 may be configured to extract pixels from the video blocks received by the 2D to 3D conversion processor 204. In some implementations, the pixel extracting processor 404 may extract the pixels from the video block by rows. In implementations where the pixel extracting processor 404 extracts pixels by rows, the pixels may be extracted from left to right or from right to left. In some implementations, the pixel extracting processor 404 may extract pixels from the video block by columns. In implementations where the pixel extracting processor 404 extracts pixels by columns, the pixels may be extracted from top to bottom or from bottom to top.

The 3D conversion processor 204 may include a warping processor 406. The warping processor 406 may be coupled with the processor 402. The warping processor 406 may be configured to warp an extracted pixel as part of the conversion to 3D video. In some implementations, the warping processor 406 may calculate the disparity value for a pixel to determine the pixel location in the destination image. It will be understood that methods other than disparity may be used to determine a pixel location in the destination image without departing from the scope of the present disclosure. The warping processor 406 may be configured to receive extracted pixels directly from the pixel extraction processor 404. In some implementations, the pixel extraction processor 404 may provide the extracted pixels by storing them in a memory 208. In these implementations, the warping processor may be configured to retrieve the extracted pixels from the memory 208.

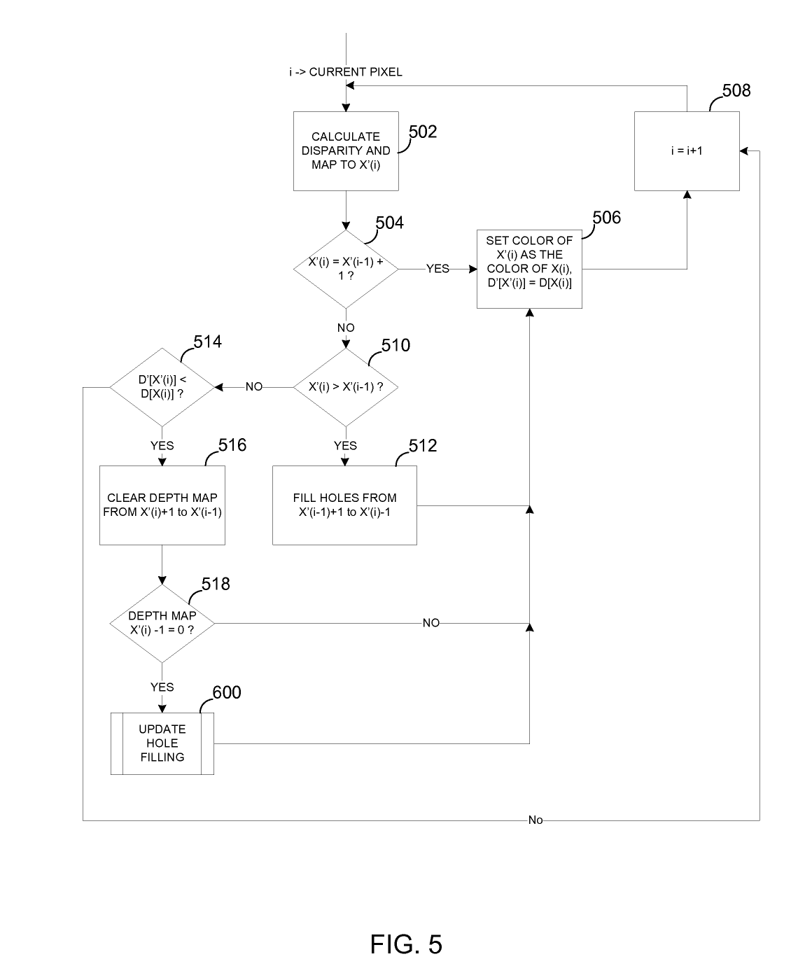

The 3D conversion processor 204 may include a hole detecting processor 408. The hole detecting processor 408 may be coupled with the processor 402. After a pixel has been warped by the warping processor 404, the hole detecting processor 408 may be configured to determine if any holes were introduced into the destination image. Spaces between one or more pixels in a destination image may be unmapped. As discussed above, a hole may be an occlusion or a pinhole. The process for detecting a hole will be described in further detail below with reference to FIG. 5. As with the warping processor 406, the hole detecting processor 408 may detect holes based on information transmitted directly from the warping processor 406, or based on information provided to the holed detecting processor 408 via the memory 208.

The 3D conversion processor 204 may include a hole filling processor 410. The hole filling processor 410 may be coupled with the processor 402. If the hole detecting processor 408 identifies a hole, a signal may be transmitted causing the hole filling processor 410 to generate pixel values for the hole. Pixel values may include information such as color (e.g., red, green, blue values), depth values (e.g., z-value), brightness, hue, saturation, intensity, and the like. The process for hole filling will be described in further detail with reference to FIG. 5. As with the warping processor 406, the hole filling processor 410 may fill holes based on information transmitted directly from the hole filling processor 406, or based on information provided to the holed filling processor 410 via the memory 208.

Once the video blocks have been processed, the converted 3D pixel values representing the destination image are outputted from the 2D to 3D conversion processor 204. In some implementations, the 3D conversion processor 204 may write one or more of the converted 3D pixel values to memory 208. In some implementations, if conversion is performed in a video encoder 22, the converted 3D pixel values may be directly transmitted to a transmission preparation processor 206. In some implementations, if conversion is performed in a video decoder 28, the converted 3D pixel values may be directly transmitted to a display preparation processor 306.

FIG. 5 shows an exemplary process flow diagram for 2D to 3D pixel warping and hole detection. The process is performed for each extracted pixel (i). In the implementation described in FIG. 5, it is assumed that the pixels are processed by rows, from left to right. At block 502, the disparity is calculated and the current pixel (i) is mapped to a location (X′(i)) in the destination image. At block 504, a determination is made as to whether the pixel value at the current location (X′(i)) is equal to the pixel value mapped to the location one pixel to the right of the previous mapped pixel (X′(i−1)+1). If so, the current pixel is mapped to a location immediately adjacent to the previously mapped pixel. If two pixels are next to each other, there is no hole between the current pixel and the previous pixel. Since there is no hole, the process continues to block 508 where the pixel counter is incremented and the process repeated for the next pixel. If the pixel counter has reached the end of a row, the process resets the pixel counter and begins processing the next row.

Returning to block 504, if the current pixel is not mapped to a location immediately to the right of the previously mapped pixel location, there may be a hole. Two possibilities exist, the current pixel location is further to the right of the previously mapped pixel location, or the current pixel location is at or to the left of the previously mapped pixel location. Decision block 510 checks for the first scenario. If the current pixel location is greater than (e.g., to the right of) the previously mapped pixel location, then one or more pixels exist between the current and previous pixels. The one or more pixels between the currently mapped pixel and previously mapped pixel represent a hole. At block 512, the hole is filled starting with the pixel location immediately to the right of the previously mapped pixel (X′(i−1)) and ending with the pixel location immediately to the left of the currently mapped pixel (X′(i)).

Assume a hole to be filled exists between two locations in the same horizontal line of a destination image, m and n, where location n is greater than (e.g., to the right of) location m. To fill a hole between m and n, the depth value for n in the destination image is compared with the depth value for m in the destination image. If the depth value for n is greater than the depth value for m, then the color values of pixel at location n is used to fill the holes between m and n. If the depth value for n is less than or equal to the depth value for m, the color values of pixel at location m is used to fill the holes. In some implementations, the depth value of n and the color values of the pixel at location n may not be set. In this case, the depth value and color values of the pixel at location n in the destination image are temporally set equal to the depth value and color values from the original view for the pixel currently mapped to pixel n.

Returning to block 510, if the currently mapped pixel location is at or to the left of the previously mapped pixel location, then the current pixel is being warped on at least one previously mapped pixel. The method proceeds to determine which pixel(s) should appear in the destination image. At decision block 514, the depth value for the current pixel in the destination image (D′[X(i)]) is compared with the depth value for the current pixel in the reference view image (D[X(i)]). In the example shown in FIG. 5, a larger depth value indicates a pixel is closer to the camera. Therefore, if the depth of the current pixel in the destination image is less than the depth of the current pixel in the reference view image, the pixel is obstructed in the destination image and may be omitted from the destination image. In this case the process continues to block 508 to process the next pixel. In some instances, all reference view image pixels, may be mapped before reaching the end of a corresponding row of destination view image pixels. In these instances, the remaining unmapped destination view pixel locations may be assigned the pixel values of the last pixel mapped in the destination view row. In other implementations, the destination view row may be post-processed using statistics or other analytics based on one or more assigned pixel location pixel values to fill the destination view row.

Returning to block 514, if the depth of the current pixel in the destination image is greater than the depth of the pixel in the reference view image, the current pixel may be obstructing other, previously mapped pixels. At block 516, the depth map values for the pixels located one pixel location to the right of the current pixel location (X′(i)+1) to the pixel location of the previously mapped pixel (X′(i−1)) is cleared. In the implementation shown in FIG. 5, clearing the depth map is accomplished by setting the value in the depth map for a pixel to a value representing a position farthest from the camera such as zero. In some implementations, the depth map may be cleared by removing an entry from the depth map associated with the pixel or setting the value in the depth map to a non-zero value.

At block 518, if the depth map value for the currently mapped pixel at the pixel location to the left of the currently mapped pixel (X′(i)−1) is not zero, then the currently mapped pixel at the pixel location to the left of the currently mapped pixel was not temporally hole filled on the basis of previously mapped pixel values. Accordingly, no conflict exists between the currently mapped pixel and the pixel at the pixel location to the left currently mapped pixel. In this case, the process advances to block 506 and continues as described above.

Returning to block 518, if the depth map value for the currently mapped pixel at the pixel location to the left of the currently mapped pixel (X′(i)−1) is zero, then one or more pixel locations may have been hole filled to the left of the currently mapped pixel. This hole filling would have been based on the previously mapped pixel values which are being overwritten by the currently mapped pixel values. In this case, the process continues to block 600. At block 600, the hole filling is updated as described below in reference to FIG. 6.

As described in FIG. 5, the depth map is used to indicate the difference between mapped pixel locations and pixel locations that have been temporally hole filled. It will be understood that other mechanisms for identifying a temporally hole filled pixel location other than the depth map may be used such as an indicator included in the pixel value, a look-up table, or the like.

FIG. 6 shows an exemplary process flow diagram for updating hole filling. In some circumstances a pixel location that received a pixel value as the result of hole filling may be re-filled in light of subsequently mapped pixels. The pixel location filled received the pixel value based on an evaluation of pixels at, say, locations A and Z. Subsequently, location N may be mapped with a different pixel value. In this case, the hole between locations A and N must be re-evaluated considering the pixel values mapped at location A and location N. FIG. 6 describes this re-evaluation process.

At block 602, a current update pixel indicator is initialized to the location to the left of the currently mapped pixel location. A counter tracking the number of temporally filled holes may also be initialized to zero. At block 604, the depth value for the pixel located at the current update pixel location is compared to zero. If the depth value of the pixel at the current update pixel location is not equal to zero, then no temporally filled hole is present at this pixel location. Recall, in some implementations setting the depth map to zero is one method for identifying temporally filled pixel locations. Accordingly, the update has identified the extent of the temporally filled hole. The process continues to a block 606 where the above mentioned hole filling process is performed for pixel locations spanning the temporally filled hole (e.g., j+1 to i−1).

Returning to decision block 604, if the depth of the pixel at this location is equal to zero, then a temporally filled hole is present at the current update pixel location. At block 608, the current update pixel location in decremented (e.g., current update pixel location shifted one pixel to the left) and the temporally filled hole count is incremented by one. At a block 610, a determination is made as to whether j has decremented to the start of the row, namely, pixel location 0. If j is less than zero, then the hole extends to the left edge of the row. The process continues to block 606 where the hole filling process is performed from the left edge of the row to i−1. If j is greater than zero, then more pixels remain in the row which may not be mapped. The process repeats the above method by returning to block 604.

FIG. 7A shows exemplary pixel mappings from a reference view to a destination view. The exemplary pixel mapping includes two rows of pixels. Row 702 includes several boxes representing pixel locations for pixels in the reference view image. Row 704 includes a corresponding number of boxes representing pixel locations for pixels in the destination view image. In FIG. 7A, a numeral (e.g., 1) represents a pixel in the reference view image and the prime version of the numeral (e.g., 1′) represents the same pixel, but in the destination image.

As shown in FIG. 7A, the first reference view image pixel location contains pixel 1. Pixel 1 has been previously mapped to the first destination image pixel location. This mapped pixel is represented by pixel 1′ in the destination image. In this example, no offset was needed to warp pixel 1 during mapping to the first pixel location in the destination view image. In FIG. 7A, reference view image pixel 2 at the second reference view image pixel location is being mapped to a destination view image pixel location. As shown, reference view image pixel 2 is mapped to the second destination view image pixel location as pixel 2′. As with pixel 1, no offset was needed to warp pixel 2 during the mapping of the second pixel location in the destination view image. Once the pixel 2 is mapped, the system determines if any holes exist between the currently mapped pixel location and the previously mapped pixel location. Since pixel 2′ is mapped to the pixel location immediately to the right of the pixel location of the previously mapped pixel, 1′, no holes exist. Thus, no hole filling is necessary as a result of mapping pixel 2.

FIG. 7B shows other exemplary pixel mappings from a reference view to a destination view. As with FIG. 7A, the exemplary pixel mapping includes two rows of pixels. Row 702 includes several boxes representing pixel locations in the reference view image. Row 704 includes a corresponding number of boxes representing pixel locations in the destination view image. FIG. 7B illustrates the mapping of reference view image pixel 3 from the third reference view image location. In this example, the system determines an offset for pixel 3 in the destination view image. The third reference view image pixel location is not mapped to the third target pixel location. Pixel 3′ is not immediately to the right of the previously mapped pixel 2′. Instead, pixel 3 is mapped with a one pixel offset, the mapped pixel represented by pixel 3′. In doing so, a hole is introduced between pixel 2′ and pixel 3′ in the destination view image. To fill the hole, the depth values for pixel 2′ and pixel 3′ are compared to determine which pixel value will be used to fill the hole. In the example shown in FIG. 7B, the depth value for pixel 2′ is greater than the depth value for 3′ in the destination view image. Thus, by this example, the pixel value of 2′ are used to fill the hole at the third pixel location of the destination view image.

FIG. 7C shows other exemplary pixel mappings from a reference view to a destination view. As with FIGS. 7A and 7B, the exemplary pixel mapping includes two rows of pixels. Row 702 includes several boxes representing pixel locations in the reference view image. Row 704 includes a corresponding number of boxes representing pixel locations in the destination view image. FIG. 7C illustrates the mapping of reference view image pixel 4 from the fourth reference view image location. In this example, the system determines an offset for pixel 4 in the destination view image. The fourth reference view image pixel location is not mapped to the next available destination view image pixel location (e.g., the sixth location). Pixel 4′ is not immediately to the right of the previously mapped pixel 3′. Instead, pixel 4 is mapped with a one pixel offset from the previously mapped pixel location, the mapped pixel represented by pixel 4′. In doing so, a hole is introduced between pixel 3′ and pixel 4′ in the destination view image. To fill the hole, the depth values for pixel 3′ and pixel 4′ are compared to determine which pixel value will be used to fill the hole. In the example shown in FIG. 7C, the depth value for pixel 4′ is greater than the depth value for 3′ in the destination view image. Thus, by this example, the pixel value of pixel 4′ are used to fill the hole in the destination view image.

FIG. 7D shows other exemplary pixel mappings from a reference view to a destination view. As with FIGS. 7A, 7B, and 7C the exemplary pixel mapping includes two rows of pixels. Row 702 includes several boxes representing pixel locations in the reference view image. Row 704 includes a corresponding number of boxes representing pixel locations in the destination view image. FIG. 7D illustrates the mapping of reference view image pixel 5 from the fifth reference view image location. In this example, the system determines an offset for pixel 5 in the destination view image. Unlike the offset from FIG. 7C, the offset for pixel 5 is to the left of the previously mapped pixel location. According to the method described in FIG. 5, the depth value for 4′ in the destination view image will be cleared (e.g., set to zero). The system then updates the hole filling for the fifth pixel location in the destination view image based on the pixel values for 3′ and 5′ as described above. In the example shown, the pixel value for pixel 5′ are used to fill the fifth pixel location in the destination view image.

FIG. 7E shows another exemplary pixel mapping from a reference view to a destination view. As with FIGS. 7A, 7B, 7C, and 7D the exemplary pixel mapping includes two rows of pixels. Row 702 includes several boxes representing pixel locations in the reference view image. Row 704 includes a corresponding number of boxes representing pixel locations in the destination view image. FIG. 7E illustrates the mapping of reference view image pixel 6 from the sixth reference view image location. The system calculates no offset from the previously mapped pixel location (e.g., the sixth location). Accordingly, pixel 6 is mapped to the seventh pixel location as pixel 6′ in the destination view image. In this example, the pixel value for pixel 6′ overwrite the previous pixel value of the sixth location (e.g., the values of pixel 4′).

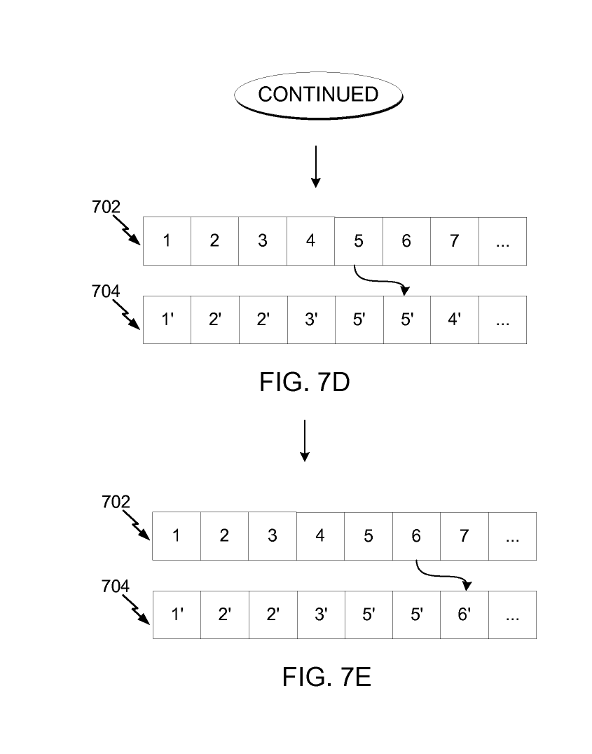

FIG. 8 shows a flowchart for an exemplary method of generating an image. At block 802, a mapping direction is selected for processing a plurality of pixel values of a reference image at a plurality of first collinear pixel locations. At a block 804, each of the plurality of pixel values are successively mapped along the mapping direction to a respective plurality of second pixel locations of a destination image. The mapping may be accomplished using one or more of the techniques described above. At block 806, between two consecutive mappings, a location of a hole between two of the second pixel locations is determined. Determination of a hole may be accomplished using one or more of the techniques described above.

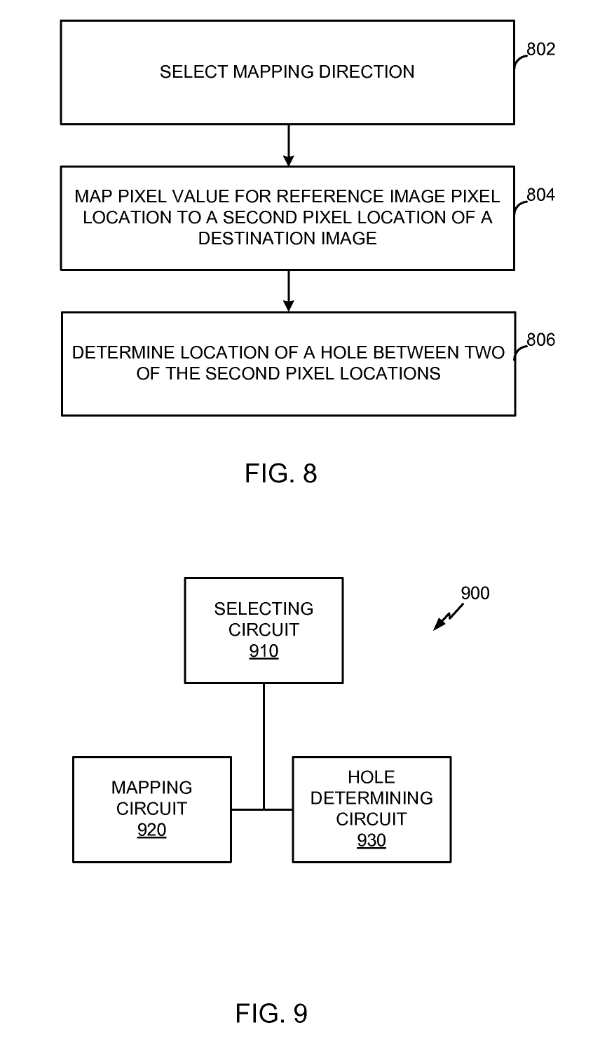

FIG. 9 shows a functional block diagram of an exemplary video conversion device. Those skilled in the art will appreciate that a wireless terminal may have more components than the simplified video conversion device 900 shown in FIG. 9. The video conversion device 900 shows only those components useful for describing some prominent features of implementations within the scope of the claims. The video conversion device 900 includes a selecting circuit 910, a mapping circuit 920 and a hole determining circuit 930. In some implementations, the selecting circuit 910 is configured to select a mapping direction to process a plurality of pixel values of a reference image at a plurality of first collinear pixel locations. In some implementations, the means for selecting comprises a selecting circuit 910. In some implementations, the mapping circuit 920 is configured to successively map, along the mapping direction, each of the plurality of pixel values to a respective plurality of second pixel locations of a destination image. In some implementations, the means for successively mapping includes a mapping circuit 920. In some implementations, the hole determining circuit 930 is configured to, between two consecutive mappings, determine a location of a hole between two of the second pixel locations. The means for determining a location of a hole may include a hole determining circuit 930.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than or equal to a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

Moreover, the word “exemplary” is used herein to mean “serving as an example, instance, or illustration.” Any embodiment described herein as “exemplary” is not necessarily to be construed as preferred or advantageous over other embodiments.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A method of video image processing, comprising:
selecting a mapping direction to process a plurality of pixel values of a reference image at a plurality of first collinear pixel locations;
successively mapping, along the mapping direction, each of the plurality of pixel values to a respective plurality of second pixel locations of a destination image; and
between two consecutive mappings, determining a location of a hole between two of the second pixel locations.

2. The video image processing method of claim 1, wherein determining the location of a hole comprises identifying a pixel location between a first mapped-to location in the destination image and a second mapped-to location in the destination image, the second mapped-to location being a location in a same direction as the mapping direction.

3. The video image processing method of claim 1, further comprising, between a first mapped-to location in the destination image and a second mapped-to location in the destination image, the first mapped-to location and the second mapped-to location being consecutive mappings, determining a pixel value for the second mapped-to location, if the mapped-to pixel locations are the same or have an opposite direction in the destination image as the mapping direction.

4. The video image processing method of claim 2, further comprising determining a pixel value for a location determined to be a hole based on a comparison of depth values from the reference image for a pixel at the first mapped-to location and a pixel at the second mapped-to location.

5. The video image processing method of claim 3, wherein the pixel value for the second mapped-to location is based on a comparison of depth values from the reference image for a pixel at the first mapped-to location and a pixel at the second mapped-to location.

6. The video image processing method of claim 3, wherein the pixel value includes a color component and an intensity value associated with the color component.

7. The video image processing method of claim 1, wherein mapping each of a plurality of pixel values comprises mapping from a 2D reference image to a 3D destination image.

8. The video image processing method of claim 7, wherein the 3D destination image comprises a 3D stereo image pair including the 2D reference image.

9. The video image processing method of claim 1, further comprising:
setting a depth value for a location in the destination image upon mapping a pixel value to the location, wherein the location is a non-hole; and
when the location is a hole, identifying the location as unmapped until the location is subsequently mapped-to.

10. The video image processing method of claim 3, further comprising:
if the pixel value of the second mapped-to location is used as the pixel value of the determined location, detecting in an opposite direction of the mapping direction, pixel locations which are marked as unmapped and are adjoining to the second mapped-to location in the destination image; and
identifying the detected pixel locations as a continuous hole.

11. The video image processing method of claim 10, wherein each pixel value of the continuous hole is determined based on a comparison of depth values of a first pixel and a second pixel which bound the continuous hole, the first and second pixel values not being holes in the destination image.

12. A video conversion device comprising:
means for selecting a mapping direction to process a plurality of pixel values of a reference image at a plurality of first collinear pixel locations;
means for successively mapping, along the mapping direction, each of the plurality of pixel values to a respective plurality of second pixel locations of a destination image; and
means for, between consecutive mappings, determining a location of a hole between two of the second pixel locations.

13. The device of claim 12, wherein the means for determining a location of a hole are configured to identify a pixel location between a first mapped-to location in the destination image and a second mapped-to location in the destination image, the second mapped-to location being a location in a same direction as the mapping direction.

14. The device of claim 13, further comprising means for determining a pixel value for the determined location based on a comparison of depth values from the reference image for a pixel at the first mapped-to location and a pixel at the second mapped-to location.

15. The device of claim 12, further comprising means for, between a first mapped-to location in the destination image and a second mapped-to location in the destination image, the first mapped-to location and the second mapped-to location being consecutive mappings, determining a pixel value for the second mapped-to location, if the mapped-to pixel locations are the same or have an opposite direction in the destination image as the mapping direction.

16. The device of claim 15, further comprising means for determining a pixel value for a location determined to be a hole based on a comparison of depth values from the reference image for a pixel at the first mapped-to location and a pixel at the second mapped-to location.

17. The device of claim 16, wherein the pixel value for the second mapped-to location is based on a comparison of depth values from the reference image for a pixel at the first mapped-to location and a pixel at the second mapped-to location.

18. The device of claim 12, wherein the means for successively mapping each of a plurality of pixel values is configured to map from a 2D reference image to a 3D destination image and wherein the 3D destination image comprises a 3D stereo image pair including the 2D reference image.

19. A video conversion device comprising:
a processor;
a pixel extracting circuit coupled with the processor and configured to consecutively extract pixels from a reference image in a specified mapping direction;
a pixel warping circuit coupled with the processor and configured to determine a location for an extracted pixel in a destination image;
a hole detecting circuit coupled with the processor and configured to identify an empty pixel location in the destination image between the location for the extracted pixel and a previously determined location for a previously extracted pixel; and
a hole filling circuit coupled with the processor and configured to generate a pixel value for the empty pixel location in the destination image.

20. The device of claim 19, wherein the pixel extracting circuit is configured to extract a second pixel after the hole detecting circuit and hole filling circuit finish operation on a first pixel.

21. The device of claim 19, wherein reference image is a 2D image and wherein the destination image is a 3D destination image comprising a 3D stereo image pair including the 2D reference image.

22. The device of claim 19, wherein the pixel warping circuit is configured to determine a location for the extracted pixel in the destination image based on an offset from the pixel location in the reference image.

23. The device of claim 19, wherein the hole detecting circuit is configured to identify, between a first mapped-to location in the destination image and a second mapped-to location in the destination image, the first mapped-to location and the second mapped-to location being consecutive mappings, determining a pixel value for the second mapped-to location, if the mapped-to pixel locations are the same or have an opposite direction in the destination image as the mapping direction.

24. The device of claim 23, wherein the hole filling circuit is configured to generate the pixel value for the second mapped-to location is based on a comparison of depth values from the reference image for a pixel at the first mapped-to location and a pixel at the second mapped-to location.

25. The device of claim 19, wherein the hole detecting circuit is configured to identify an empty pixel location between a first mapped-to location in the destination image and a second mapped-to location in the destination image, the second mapped-to location having a same direction as the mapping direction.

26. The device of claim 25, wherein the hole filling circuit is configured to generate a pixel value for the identified empty pixel location based on a comparison of depth values from the reference image for a pixel at the first mapped-to location and a pixel at the second mapped-to location.

27. The device of claim 19, wherein the hole filling circuit is further configured to set a depth value for a location in the destination image upon mapping a pixel value to the location, wherein the location is a non-hole and, when the location is a hole, identify the location as unmapped until the location is subsequently mapped-to.

28. A video image processing computer program product comprising a computer-readable medium having stored thereon instructions that when executed cause an apparatus to:
select a mapping direction to process a plurality of pixel values of a reference image at a plurality of first collinear pixel locations;
successively map, along the mapping direction, each of the plurality of pixel values to a respective plurality of second pixel locations of a destination image; and
between two consecutive mappings, determine a location of a hole between two of the second pixel locations.

29. The video image processing computer program product of claim 28, wherein determining the location of a hole comprises identifying a pixel location between a first mapped-to location in the destination image and a second mapped-to location in the destination image, the second mapped-to location being a location in a same direction as the mapping direction.

30. The video image processing computer program product of claim 28 further comprising instructions causing the apparatus to, between a first mapped-to location in the destination image and a second mapped-to location in the destination image, the first mapped-to location and the second mapped-to location being consecutive mappings, determine a pixel value for the second mapped-to location, if the mapped-to pixel locations are the same or have an opposite direction in the destination image as the mapping direction.

31. The video image processing computer program product of claim 29, further comprising instructions causing the apparatus to determine a pixel value for the determined location based on a comparison of depth values from the reference image for a pixel at the first mapped-to location and a pixel at the second mapped-to location.

32. The video image processing computer program product of claim 30 further comprising instructions causing the apparatus to determine a pixel value for the determined location based on a comparison of depth values from the reference image for a pixel at the first mapped-to location and a pixel at the second mapped-to location.

33. The video image processing computer program product of claim 28, wherein mapping each of a plurality of pixel values comprises mapping from a 2D reference image to a 3D destination image and wherein the 3D destination image comprises a 3D stereo image pair including the 2D reference image.

34. The video image processing computer program product of claim 28 further comprising instructions causing the apparatus to:
set a depth value for a location in the destination image upon mapping a pixel value to the location, wherein the location is a non-hole; and
when the location is a hole, identify the location as unmapped until the location is subsequently mapped-to.
